(19) United States
(12) Patent Application Publication
(10) Pub. No.: US 2025/0306930 A1
(43) Pub. Date: Oct. 2, 2025

(54) LOCAL MEMORY DISAMBIGUATION FOR A PARALLEL ARCHITECTURE WITH COMPUTE SLICES

(71) Applicant: Ascenium, Inc., Mountain View, CA (US)

(72) Inventors: Jacob John Vorland Taylor, 0383 Oslo (NO); Anders Schau Knatten, 0463 Oslo (NO)

(73) Assignee: Ascenium, Inc., Mountain View, CA (US)

(21) Appl. No.: 19/093,385

(22) Filed: Mar. 28, 2025

Related U.S. Application Data
(60) Provisional application No. 63/571,483, filed on Mar. 29, 2024.
(60) Provisional application No. 63/642,391, filed on May 3, 2024.
(60) Provisional application No. 63/659,401, filed on Jun. 13, 2024.
(60) Provisional application No. 63/744,394, filed on Jan. 13, 2025.

(51) Int. Cl. G06F 9/30; G06F 9/38; G06F 9/46

(52) U.S. Cl. CPC G06F 9/30043; G06F 9/3836; G06F 9/461

(57) ABSTRACT

A processing unit is accessed, comprising compute slices, a control unit, local memory disambiguation units (LMDUs), and memory system. Each slice includes an execution unit and is coupled to successor and predecessor slices. Each slice is coupled to an LMDU. The control unit distributes a first slice task to a first slice coupled to a first LMDU. The first slice executes the first task. The task includes a load instruction including a load address. The first slice issues the load instruction to the first LMDU. The issuing saves load information in a memory operation table (MOT) within the LMDU. The LMDU detects, based on the MOT, address aliasing between the load address and a store address of a previous store instruction. The MOT forwards store information from the previous store instruction. The store information satisfies one or more bytes of data required for the load instruction.

### RELATED APPLICATIONS

This application claims the benefit of U.S. provisional patent applications “Local Memory Disambiguation For A Parallel Architecture With Compute Slices” Ser. No. 63/571,483, filed Mar. 29, 2024, “Global Memory Disambiguation For A Parallel Architecture With Compute Slices” Ser. No. 63/642,391, filed May 3, 2024, “Memory Dependence Prediction In A Parallel Architecture With Compute Slices” Ser. No. 63/659,401, filed Jun. 13, 2024, and “Code Translation And Forwarding With Compute Slices” Ser. No. 63/744,394, filed Jan. 13, 2025.

Each of the foregoing applications is hereby incorporated by reference in its entirety.

### FIELD OF ART

This application relates generally to memory operations and more particularly to local memory disambiguation for a parallel architecture with compute slices.

### BACKGROUND

Advancements in computing technology have vastly enhanced data processing efforts of researchers, corporations, hospitals, schools, and others. As advancements in each of these areas are achieved, new theories, models, and applications are developed. The result is an ever-increasing demand for better computing technologies. That is, demand leads to improvements in computing, and improvements in computing achieve processing objectives. The computing technologies that are brought to bear on processing can be large and complex. These modern technologies, which still employ logic gates, are a far cry from the very earliest electronic computers. Conceptually, the idea of using vacuum tubes as logic gates was established prior to 1920. However, it wasn't until the late 1930s that the first vacuum tube computer was developed. The ENIAC computer soon followed with its thousands of vacuum tubes that required copious amounts of electricity while only providing a then heady 450 floating point operations per second (FLOPS).

Computers slowly evolved and achieved a steady increase in processing power. The invention of the transistor in 1947 enabled a new generation of computers, providing applications previously unachievable with vacuum-tube technology. Programming techniques advanced as compute power increased. Computer languages such as COBOL and FORTRAN were created to replace hard-to-use punch cards. These programming languages significantly sped the process of making compute resources accessible to engineers to solve everyday problems. In the late 1950s, the first integrated circuit (IC) was created, and with it, a new era in computer technology. From here, the rate and pace of technological change intensified, including the development of the first general purpose microprocessor, the DRAM chip, and the floppy drive. These devices enabled the first marketable personal computers.

Electronic processors are now found in a wide variety of electronic devices. Smartphones now have more than a million times the compute power of early computers. A standard personal computer today is roughly capable of tens of gigaFLOPs (1 billion floating point operations per second). Meanwhile, the world's fastest supercomputer is much more powerful, with more than eight million processor cores and a total compute power surpassing one exaFLOP (1 quintillion floating point operations per second). Predictably, this exponential increase in compute power has opened a world of new and powerful applications. Augmented reality, genomic sequencing, machine learning, artificial intelligence, cancer treatments, and autonomous vehicles are just a small sample of what has become possible with the power of today's high-performance processors and compute systems. In the future, human ingenuity will surely continue to push the technical boundaries of possibility as more processing power and new applications become available.

### SUMMARY

From the earliest days of the computer age, engineers have invented techniques, technologies, and architectures for increasing performance of computer systems. Increased clock speeds have been implemented successfully to increase the processing capability of modern compute systems. However, circuit power dissipation has severely limited the extent to which clock speeds can be pushed. As a result, the growth in processor clock rates has slowed because cooling technologies have not been able to keep pace with the excessive heat dissipation of modern designs. Parallelism has offered an additional method to increase performance. For example, a microprocessor chip can include any number of smaller processor cores, each able to perform operations in parallel. This approach, while common, has required engineers to devise methods that ensure that each core has access to read from and write to memory. The system must also be prevented from receiving stale data, and must deliver the most updated data to all processing elements when required. As more and more parallelism has been added to microprocessor chips, memory system design has become a significant challenge. To address the continued need for increased performance, local disambiguation for a parallel architecture with compute slices is disclosed.

Techniques for local memory disambiguation for a parallel architecture with compute slices are disclosed. A processing unit is accessed. The processing unit can be based on one or more integrated circuits or chips, application-specific chips, programmable chips, and so on. The processing unit includes various electronic elements that enhance the unit. The electronic elements include a plurality of compute slices, a control unit, a plurality of local memory disambiguation units (LMDUs), and a memory system. Each compute slice within the plurality of compute slices includes at least one execution unit. Each compute unit is coupled to a successor compute slice and a predecessor compute slice. Each compute slice within the plurality of compute slices is coupled to an LMDU in the plurality of LMDUs. The LMDUs can be used to provide some or all data required by a memory access load operation. The control unit distributes a first slice task to a first compute slice within the plurality of compute slices. The slice task includes one or more instructions such as arithmetic, logic, and memory access instructions. The first compute slice is coupled to a first LMDU within the plurality of LMDUs. The first compute slice executes the first slice task. The first slice task includes a load instruction, where the load instruction includes a load address. The first compute slice issues the load instruction to the first LMDU. The issuing includes saving, in a memory operation table (MOT) within the LMDU, load information associated with the load instruction. The LMDU detects address aliasing between the load address and a store address of a previously issued store instruction. The detecting is based on the MOT. The detecting that a store instruction and a load instruction alias to the same address indicates that load data required by the load instruction may be available in the MOT. The MOT forwards store information from the previously issued store instruction. The store information can include one or more bytes of data. The store information satisfies one or more bytes of data required for the load instruction. When the store data does not satisfy all of the bytes required for the load instruction, the load instruction can be sent to a global memory disambiguation unit (GMDU). The GMDU performs global alias checking against the load instruction. The global alias checking includes one or more other LMDUs in the plurality of LMDUs. When a match is found, the GMDU provides the load instruction with one or more additional bytes of data required for the load instruction.

A processor-implemented method for checking memory operation is disclosed comprising: accessing a processing unit comprising a plurality of compute slices, a control unit, a plurality of local memory disambiguation units (LMDUs), and a memory system, wherein each compute slice within the plurality of compute slices includes at least one execution unit, and is coupled to a successor compute slice and a predecessor compute slice, wherein each compute slice within the plurality of compute slices is coupled to an LMDU in the plurality of LMDUs; distributing, by the control unit, a first slice task to a first compute slice within the plurality of compute slices, wherein the first compute slice is coupled to a first LMDU within the plurality of LMDUs; executing, by the first compute slice, the first slice task, wherein the first slice task includes a load instruction, and wherein the load instruction includes a load address; issuing, by the first compute slice, the load instruction to the first LMDU, wherein the issuing includes saving, in a memory operation table (MOT) within the LMDU, load information associated with the load instruction; detecting, by the LMDU, address aliasing between the load address and a store address of a previously issued store instruction, wherein the detecting is based on the MOT; and forwarding, by the MOT, store information from the previously issued store instruction, wherein the store information satisfies one or more bytes of data required for the load instruction.

In embodiments, the memory system includes a global memory disambiguation unit (GMDU), and wherein each LMDU in the plurality of LMDUs is coupled to the GMDU. In embodiments, the issuing includes sending, by the first LMDU, the load instruction to the GMDU. Some embodiments comprise marking, by the memory operation table, the load instruction as issued. Some embodiments comprise performing, by the GMDU, global alias checking against the load instruction, wherein the global alias checking includes one or more other LMDUs in the plurality of LMDUs. Some embodiments comprise providing, by the GMDU, the load instruction with one or more additional bytes of data required for the load instruction.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for local memory disambiguation for a parallel architecture with compute slices.

FIG. 2 is a flow diagram for managing tokens.

FIG. 3 is a block diagram for a compute slice and load-store unit control.

FIG. 4 is a block diagram for a ring configuration of compute slices and load-store units.

FIG. 5 is a first example of forwarding data.

FIG. 6 is a second example of forwarding data.

FIG. 7 is a third example of forwarding data.

FIG. 8 is a fourth example of forwarding data.

FIG. 9 is a fifth example of forwarding data.

FIG. 10 is a sixth example of forwarding data.

FIG. 11 is a seventh example of forwarding data.

FIG. 12 is a system diagram for local memory disambiguation for a parallel architecture with compute slices.

### DETAILED DESCRIPTION

The computational requirements of a wide variety of organizations are continuously driving the demand for greater compute power. Computationally intensive applications such as artificial intelligence are increasingly being applied to common tasks. Even “low-tech” organizations are faced with a need to upgrade their compute resources in order to remain competitive. Faster processor clock speeds have been applied with great success to increase the processing capabilities of modern compute systems. Yet, there are performance limitations. Cooling technology has been woefully inadequate to meet demands of processor technologies resulting from improved lithography and increased clock frequencies, impelling other methods of performance improvements, such as parallelism, to be explored. Implementing parallelism can be accomplished by increasing the number of execution units on a processor, and/or adding multiple processor cores to the same chip. The parallelism enables threading within the processor. These design options increase overall performance by enabling the system to take advantage of more instruction level parallelism (ILP). That said, these approaches also come with significant cost and complexity. For example, instructions and data must be able to move efficiently and concurrently in and out of multiple processor cores on the same chip so that the processors do not stall. Processor stalling can reduce or eliminate any performance enhancement that was achieved. Further, memory semantics must be maintained across all cores in the system so that the contents of memory do not become corrupted, and each core operates on the most recent data, even if updated by another core in the system. Thus, highly efficient memory system designs have become a key piece to increase processor performance.

To address the continued need for increased performance, a parallel architecture with compute slices and local memory disambiguation is disclosed. A compiled program is divided into slice tasks. Slice tasks comprise code sequences of various sizes which include at least one load instruction. A control unit within a processing unit can allocate any number of slice tasks to compute slices. The allocation is based on one slice task at a time per compute slice. The control unit can allocate a first slice task, which can be a predecessor task, that can run non-speculatively. In some embodiments, all other successive slice tasks run speculatively. The control unit can allocate a first slice task to a first compute slice pointed to by a pointer such as a head pointer. The first compute slice can execute the first slice task. The first slice task includes a load instruction. The load instruction includes a load address from which the load data is to be obtained. The first compute slice issues the load instruction to a first local memory disambiguation unit (LMDU). Load information associated with the load instruction is saved in a memory operation table (MOT) within the LMDU. Load information such as the load address is checked against other addresses in the MOT. Address aliasing is detected between the load address and a store address of a previously issued store instruction. The detecting is based on the MOT. The MOT forwards store information from the previously issued store instruction. The store information satisfies one or more bytes of data required for the load instruction.

Each compute slice is coupled to a successor compute slice and a predecessor compute slice by a barrier register set. The coupling can result in a ring configuration. The coupling of the compute slices enables data communication between compute slices. For example, a current compute slice can be coupled to an immediately succeeding compute slice by a current barrier register set. The current barrier register set provides unidirectional communication from the current compute slice to the successor compute slice. Thus, the first compute slice can write to the first barrier register set and the successor compute slice can read from the first barrier register set. Pointers are used to determine how slice tasks are assigned and controlled by the control unit. The pointers can be part of the internal control unit state. The pointers can include a head pointer and a tail pointer. Embodiments include initializing pointers, wherein a head pointer points to the first compute slice, and wherein a tail pointer points to the second compute slice. The tail pointer can point to a subsequent compute slice in the plurality of compute slices. The pointers can point to a slice task that is executing speculatively and a slice task that is executing non-speculatively. In embodiments, the head pointer points to a slice task that is running non-speculatively. The compute slice that is executing non-speculatively is known to be part of the executed program. In embodiments, the tail pointer indicates which compute slice was the last to receive a slice task by the control unit. A head slice can be a compute slice which is pointed to by the head pointer. Likewise, a tail slice can be a compute slice pointed to by a tail pointer. In embodiments, a compute slice can execute speculatively if it is not the head slice. In other embodiments, the control unit distributes a slice task to a compute slice succeeding the tail slice. After distribution, the control unit can update the tail slice to point to the succeeding compute slice for further distribution of slice tasks to downstream compute slices. The head pointer and the tail pointer can be updated, by the control unit, based on slice task execution status, branch operation outcome determination, and so on. Executing multiple slice tasks on two or more compute slices enables parallelized operations, thus increasing performance.

Programs that are executed by the compute slices within the processing unit can be associated with a wide range of applications. The applications can be based on data manipulation, such as image, video, or audio processing applications; AI and machine learning applications; business applications; data processing and analysis; and so on. The slice tasks that are executed can perform a variety of operations including arithmetic operations, shift operations, logical operations including Boolean operations, vector or matrix operations, tensor operations, and the like. The slice tasks can be executed based on branch prediction, operation precedence, priority, coding order, amount of parallelization, data flow, data availability, compute slice availability, communication channel availability, and so on. Slice tasks that comprise a compiled program are generated by a compiler. The compiler can include a general-purpose compiler, a hardware description-based compiler, a compiler written or “tuned” for the specific number of compute slices in the processing unit, a constraint-based compiler, a satisfiability-based compiler (SAT solver), and so on. Control is provided to the hardware by the control unit which allocates slice tasks to compute slices. Once issued, the slice tasks can execute independently from the control unit and other compute slices until they are either halted by the control unit, indicate an exception, finish executing, etc. In this way, a compiled task can be executed by the processing unit.

The compute slices within the processing unit can be implemented with central processing units (CPUs), graphics processing units (GPUs), application specific integrated circuits (ASICs), field programmable gate arrays (FPGAs), processing cores, or other processing components or combinations of processing components. The compute slices can include heterogeneous processors, homogeneous processors, processor cores within an integrated circuit or chip, etc. The compute slices can be coupled to local storage, which can include load-store units, local memory elements, register files, cache storage, etc. The cache, which can include a hierarchical cache such as an L1, L2, and L3 cache, can be used for storing data such as intermediate results, compute slice operations, and the like. Any level of cache (e.g., L1, L2, L3, etc.) can be shared by two or more compute slices. The local storage can be coherent.

Checking memory operations is enabled by accessing a processing unit comprising a plurality of compute slices, a control unit, a plurality of local memory disambiguation units (LMDUs), and a memory system. Each compute slice within the plurality of compute slices includes at least one execution unit. The execution unit can include multicycle elements for multiplication, division, and square root computations; arithmetic logic units (ALUs); storage elements; scratchpads; and other components. The components can communicate among themselves to exchange data, signals, and so on. Each compute slice can be coupled to a successor (next) compute slice and a predecessor (previous) compute slice. Further, each compute slice can include a unique LMDU. Additionally, each LMDU can be coupled to a global memory disambiguation unit (GMDU). The control unit can distribute a first slice task to a first compute slice. The first slice task can include a set of instructions that will be executed by a first compute slice. The slice task can include at least one load instruction. The compute slice can include a current LMDU. The load instruction can be issued by the first compute slice to the first LMDU. The issuing includes saving, in a memory operation table (MOT) within the LMDU, load information associated with the load instruction. The LMDU detects address aliasing between the load address and a store address of a previously issued store instruction. The detecting is based on the MOT. The MOT forwards store information from the previously issued store instruction. The store information satisfies one or more bytes of data required for the load instruction. Further bytes that are needed to satisfy the load instruction can be obtained from a global memory disambiguation unit (GMDU). The GMDU can “look across” other LMDUs to determine if the data needed to satisfy the load instruction is available in one of the other LMDUs.

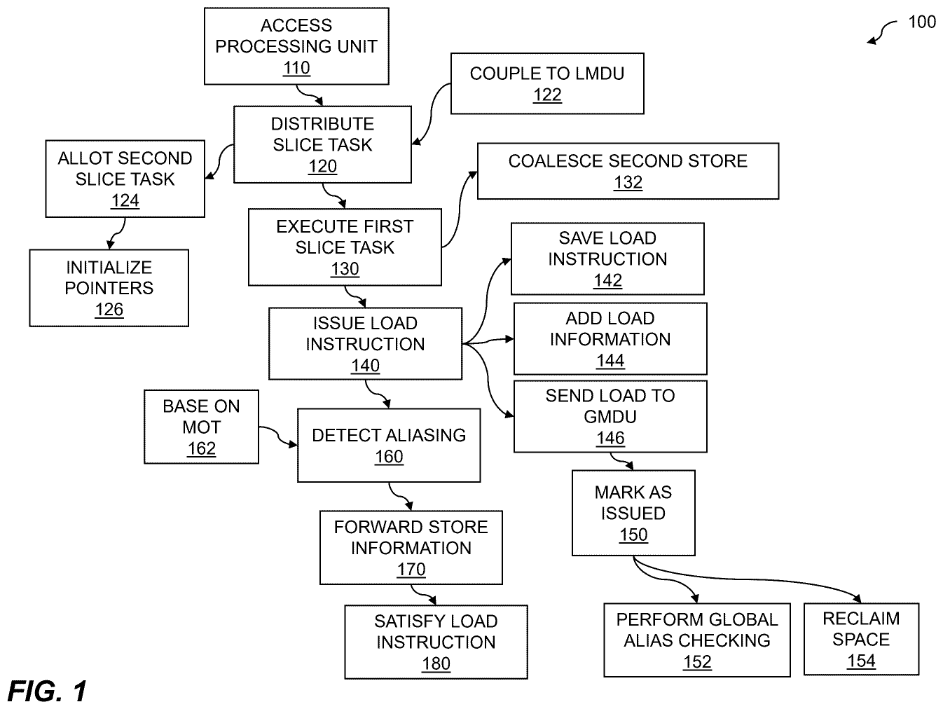

FIG. 1 is a flow diagram for local memory disambiguation for a parallel architecture with compute slices. Compute slices within a processing unit can be issued blocks of code, called slice tasks, for execution. The processing unit can include any number of compute slices. The slice tasks can be associated with a compiled program. The compiled program, when executed, can perform a variety of operations associated with data processing. The processing unit can include elements such as compute slices, a control unit, local memory disambiguation units (LMDUs), barrier register sets, and a memory system. The processing unit can further interface with other elements such as ALUs, memory management units (MMUs), GPUs, multicycle elements (MEMs), and so on. The operations can accomplish a variety of processing objectives such as application processing, data manipulation, data analysis, modeling and simulation, and so on. The operations can accomplish artificial intelligence (AI) applications such as machine learning. The operations can manipulate a variety of data types including integer, real, and character data types; vectors, matrices, and arrays; tensors; etc. To maintain the integrity of the program, all memory operations are committed in program order. Load instructions associated with a slice task can be checked against previously executed store instructions. In embodiments, the checking can be performed against a previously executed store instruction that occurs in the same slice task as the load. When an address alias is detected, store information from the previously issued store instruction can be forwarded to the load instruction. The forwarding can be performed when the store information satisfies one or more bytes of data required for the load instruction.

The flow 100 includes accessing 110 a processing unit comprising a plurality of compute slices, a control unit, a plurality of local memory disambiguation units (LMDUs), and a memory system, wherein each compute slice within the plurality of compute slices includes at least one execution unit, and is coupled to a successor compute slice and a predecessor compute slice, wherein each compute slice within the plurality of compute slices is coupled to an LMDU in the plurality of LMDUs. The compute slices within the processing unit can be implemented with central processing units (CPUs), graphics processing units (GPUs), application specific integrated circuits (ASICs), field programmable gate arrays (FPGAs), processing cores, or other processing components or combinations of processing components. The compute slices can include heterogeneous processors, homogeneous processors, processor cores within an integrated circuit or chip, etc. In embodiments, compute slices within the processing unit have identical functionality. In other embodiments, the compute slices within the processing unit have different functionality. The compute slices can be coupled to a barrier register set which can enable data transfer between compute slices. The compute slices can share a variety of computational resources within the processing unit. In embodiments, the plurality of compute slices is coupled in a ring configuration. The ring configuration can include barrier registers which are coupled between compute slices. Other topologies are possible. The topology can be selected for a specific application such as machine learning. A topology for machine learning can include supervised learning, unsupervised learning, reinforcement learning, and other machine learning topologies. A topology for machine learning can include an artificial neural network topology. The LMDUs are coupled to a memory system. In embodiments, the memory system includes a global memory disambiguation unit (GMDU), and wherein each LMDU in the plurality of LMDUs is coupled to the GMDU. The GMDU can “look across” each LMDU within the plurality of LMDUs. Each compute slice can include an LMDU.

The execution units within the compute slices can include multicycle elements for multiplication, division, and square root computations; arithmetic logic units (ALUs); storage elements; scratchpads; and other components. The components can communicate among themselves to exchange data, signals, and so on. In embodiments, more than one processing unit can be accessed. Two or more processing units can be colocated on an integrated circuit or chip, on multiple chips, and the like. In embodiments, two or more processing units can be stacked to form a three-dimensional (3D) configuration. The memory system can include local memory elements, register files, cache storage, etc. The cache, which can include a hierarchical cache, can be used for storing data such as intermediate results, compute slice operations, and the like. The cache can include an L1 cache, L2 cache, L3 cache, and so on. Any level of cache can be shared by two or more compute slices. In embodiments, the cache architecture is write-through. In other embodiments, the cache architecture is write-back. In some embodiments, the hierarchical cache is coherent. The control unit can be coupled to each of the compute slices within the processing unit. The control unit and the compute slices can communicate status information about the compute slice and the execution status of a slice task. In embodiments, the status information can include bits which determine the state of the compute slice, such as idle, executing, holding, done, and so on.

A compiled program is divided into slice tasks. Slice tasks comprise code sequences of various sizes which include at least one load instruction. A control unit can allocate any number of slice tasks to compute slices, one slice task per compute slice. The control unit can allocate a first slice task, which can be a predecessor slice task that can run non-speculatively while all other successive slice tasks run speculatively. The control unit can allocate a second slice task to a second compute slice, which can execute on the next immediate successor compute slice while the first slice task is executing. The second slice task can be executed speculatively. Successor slice tasks can be allocated by the control unit at any time during execution of the compiled program.

Each compute slice is coupled to a successor compute slice and a predecessor compute slice by a barrier register set. The coupling can result in a ring configuration. The coupling of the compute slices enables data communication between compute slices. For example, a current compute slice can be coupled to an immediately succeeding compute slice by a current barrier register set. The current barrier register set provides unidirectional communication from the current compute slice to the successor compute slice. Thus, the current compute slice can write to the current barrier register set and the successor compute slice can read from the current barrier register set. Pointers are used to determine how slice tasks are assigned and controlled by the control unit. The pointers can be part of the internal control unit state. The pointers can include a head pointer and a tail pointer. In embodiments, the head pointer indicates which compute slice is executing non-speculatively, and therefore is known to be part of the executed program. In embodiments, the tail pointer indicates which compute slice was the last to receive a slice task by the control unit. A head slice can be a compute slice which is pointed to by the head pointer. Likewise, a tail slice can be a compute slice pointed to by a tail pointer. In embodiments, a compute slice can execute speculatively if it is not the head slice. In other embodiments, the control unit distributes a slice task to a compute slice succeeding the tail slice. After distribution, the control unit can update the tail slice to point to the succeeding compute slice for further distribution of slice tasks to downstream compute slices. In embodiments, the head pointer and the tail pointer point to the same compute slice. The head pointer and the tail pointer can be updated, by the control unit, based on slice task execution status, branch operation outcome determination, and so on. Executing multiple slice tasks on two or more compute slices enables parallelized operations, increasing performance.

The flow 100 includes distributing 120, by the control unit, a first slice task to a first compute slice within the plurality of compute slices. The first slice task can include one or more instructions such as arithmetic and logical instructions, memory access instructions, and so on. In the flow 100, the first compute slice is coupled 122 to a first LMDU within the plurality of LMDUs. The LMDU can determine whether two or more operations such as memory access operations access the same memory address. Discussed below, when the same memory address is accessed by two or more operations, the LMDU can determine which data can be provided by the LMDU. In embodiments, the distributing can include a second compute slice. The second compute slice can be allotted a task. In the flow 100, the distributing includes allotting a second slice task 124 to a second compute slice within the plurality of compute slices. The second compute slice can be coupled to a barrier register set, where the barrier register set is further coupled to the first compute slice. The flow 100 further includes initializing pointers 126, wherein a head pointer points to the first compute slice, and wherein a tail pointer points to the second compute slice.

As described earlier, pointers are used to determine how slice tasks are assigned and controlled by the control unit. The pointers can be part of the internal control unit state. The pointers can include a head pointer and a tail pointer. In embodiments, the head pointer indicates which compute slice is executing non-speculatively and therefore is known to be part of the compiled program. In embodiments, the tail pointer indicates which compute slice was the last to receive a slice task by the control unit. A head slice is a compute slice which is pointed to by the head pointer within the control unit. Likewise, a tail slice is a compute slice pointed to by a tail pointer within the control unit. In embodiments, a compute slice executes speculatively if it is not the head slice. Thus, the distributing can result in a compute slice executing a slice task speculatively. In other embodiments, the control unit distributes a slice task to a compute slice which succeeds the tail slice. After distribution, the control unit can update the tail pointer to point to the next succeeding compute slice for further distribution of slice tasks to downstream compute slices.

The flow 100 includes executing 130, by the first compute slice, the first slice task, wherein the first slice task includes a load instruction, and wherein the load instruction includes a load address. Discussed previously, the first slice can include one or more instructions, where the instructions can include arithmetic, logical, and memory access instructions, and so on. The memory access instructions can include store instructions and load instructions. The load instruction included in the first slice task can access an address in storage such as a memory system. In embodiments, the load instruction can include a 64-bit aligned address. Memory operations of less than 64 bits can be supported. Smaller, unaligned memory addresses can also be supported. In this case, a compute slice can break the unaligned memory address into two or more aligned addresses before passing them to its LMDU. Copies of the contents of the storage address may be available locally to the compute slice, such as in an LMDU. The flow 100 further includes coalescing 132, in the LMDU, new store information associated with a second store instruction, with the store information. The second store instruction can be executed by the compute slice based on the slice task.

The flow 100 includes issuing 140, by the first compute slice, the load instruction to the first LMDU. The issuing can be accomplished using a bus, a network such as a network-on-chip (NOC), and so on. In the flow 100, the issuing includes saving 142, in a memory operation table (MOT) within the LMDU, load information associated with the load instruction. The MOT can be used to save a variety of information such as address information, store information, and load information. In embodiments, the memory operation table includes eight entries. Each entry can include address information and at least one of a store operation, a load operation, or both. As the compute slice executes the slice task, further load operations and/or store operations can be encountered. In embodiments, the executing can include a second load instruction, wherein the second load instruction includes the load address. The flow 100 includes adding load information 144 to the MOT row associated with the second load instruction based on the load address. A similar technique can be used for a second store operation. In embodiments, the executing includes a second store instruction, wherein the second store instruction is associated with the load address. The information associated with the second store instruction can be stored in the MOT. Embodiments include coalescing, in the LMDU, new store information associated with the second store instruction with the previous store information.

Discussed previously and throughout, in embodiments, the memory system can include a global memory disambiguation unit (GMDU), and wherein each LMDU in the plurality of LMDUs is coupled to the GMDU. In the flow 100, the issuing includes sending 146, by the first LMDU, the load instruction to the GMDU. The load address associated with the load instruction that is being executed may not match an address within the MOT. Since each of the LMDUs within the processing unit is coupled to the GMDU, the GMDU can determine whether the data required by the load instruction is available in part or in whole in one of the other LMDUs. The flow 100 further includes marking 150, by the memory operation table, the load instruction as issued. In a usage example, the load address associated with a load instruction is not found in the MOT. The LMDU can “issue” the load request to the GMDU, where the GMDU can determine whether the load address is saved in one of the other LMDUs. Thus, the flow 100 further includes performing 152, by the GMDU, global alias checking against the load instruction, wherein the global alias checking includes one or more other LMDUs in the plurality of LMDUs. The global alias checking can determine whether a load address aliases to a store address of a previously issued store instruction. If aliasing is detected between the load address and a store address in one of the other LMDUs, then the other LMDU can provide some or all of the data required by a load instruction. Embodiments can include providing, by the GMDU, the load instruction with one or more additional bytes of data required for the load instruction. The flow 100 further includes reclaiming 154 a space in the memory operation table where the load information was saved, wherein the reclaiming includes resetting a valid bit.

The flow 100 includes detecting 160, by the LMDU, address aliasing between the load address and a store address of a previously issued store instruction. Discussed previously, a load address and a store address can alias to the same storage address. This aliasing can be accomplished by determining whether the data, in part or in whole, associated with the store instruction is valid and available to the load instruction. If the store data is valid, and the load instruction can obtain some or all of its needed data from the store instruction, then data can be provided to the load instruction. Providing data from the LMDU is substantially faster than accessing data in storage. In the flow 100, the detecting is based on the MOT 162. One or more store addresses saved in the MOT can be compared to the load address. When address aliasing is detected between the load address and a store address, then some or all of the load data can be obtained from the LMDU.

The flow 100 includes forwarding 170, by the MOT, store information from the previously issued store instruction. When address aliasing is detected between the load address and a store address of a previously executed store instruction, then one or more bytes of data can be forwarded to the load instruction. The store data can be forwarded when the data is valid. In the flow 100, the store information satisfies 180 one or more bytes of data required for the load instruction. The satisfying the data requirement can be based on bytes changed by the store instruction, bytes that are valid, and so on. Discussed previously, if some or all of the bytes required to satisfy the load instruction are not available in the LMDU, then the additional required bytes of data can be provided by the GMDU.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

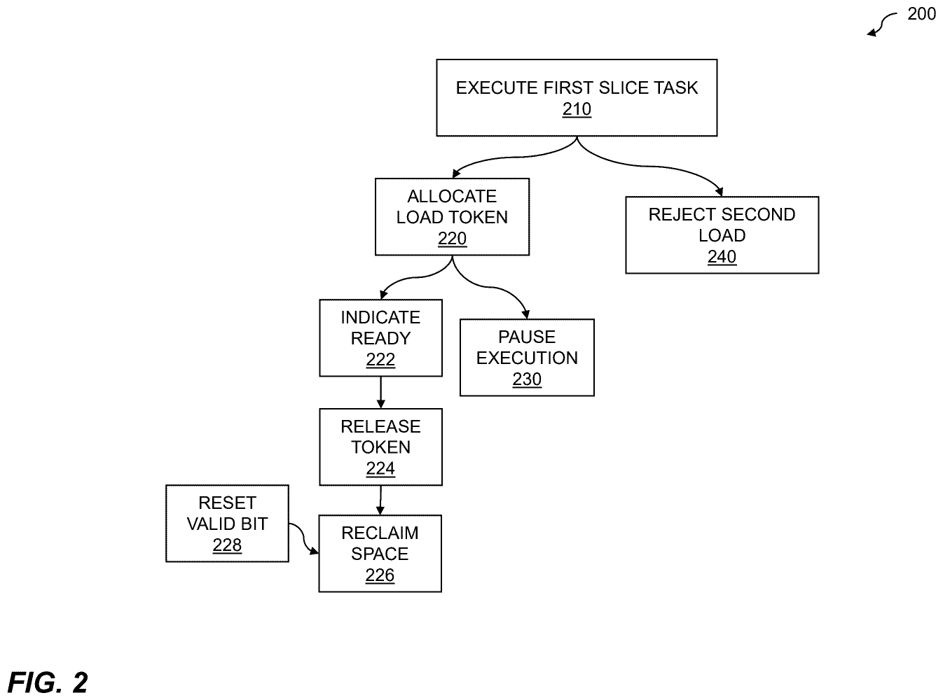

FIG. 2 is a flow diagram for managing tokens. As described above and throughout, the control unit can distribute a first compute slice task to a first compute slice within the plurality of compute slices. The first compute slice is coupled to a first LMDU within the plurality of LMDUs. The first compute slice can be executing the first slice task, where the first slice task includes a load instruction, and the load instruction includes a load address. The first compute slice can issue the load instruction to the first LMDU. The issuing can include saving, in a memory operation table (MOT) within the LMDU, load information associated with the load instruction. Load information can include a plurality of fields, where the fields can include a data file, one or more masks, an issued flag, and so on. The load information can further include a token such as a load token. The load token can include one or more bits. The load token can be used to track multiple load instructions requesting data from the same address. The load token associated with a particular load instruction can be released when the load instruction has been satisfied.

The flow 200 includes executing 210, by the first compute slice, the first slice task. The first slice task can include one or more instructions such as arithmetic, logic, and memory access instructions. In embodiments, the first slice task can include a load instruction. The load instruction can include a load address. The load address can include an aliased address. Discussed previously, the load address can alias to an address of a previously issued store instruction. In the flow 200, the executing can include allocating 220, to the load instruction, a load token. The load token can include one or more bits. In embodiments, the load token can include one bit or 32 bits. Other numbers of bits can be associated with the load token. The load token can be used to keep track of a load instruction for which there is aliasing between the load address and a store address of a previously issued store instruction. Aliasing between more than one load address and a store address of a previously issued store instruction can be detected. The additional load instructions can be assigned multibit tokens. The flow 200 further includes indicating 222 to the first compute slice that a load data associated with the load instruction is ready to be used. Some or all of the load data associated with the load instruction can be sourced from the LMDU. The indicating can be accomplished using a bit or flag such as a valid bit.

Having indicated that the load data is ready for the load instruction, the load instruction can be satisfied. The satisfying the load instruction can include forwarding one or more bytes from the LMDU to the load instruction. The flow 200 further includes releasing 224 the load token. The releasing the load token can indicate that the load instruction has been processed. The flow 200 further includes reclaiming 226 a space in the memory operation table (MOT) where the load information was saved. The space that has been reclaimed can remain unused, can be used for an additional load operation that aliases to a store address of a previously issued store instruction, and so on. In the flow 200, the reclaiming includes resetting 228 a valid bit. A bit, such as a load valid L_VALID bit associated with the aliased addresses, can be set to 0b0.

The flow 200 can further include pausing 230, by the first compute slice, execution of additional load instructions, wherein a number of load tokens has been assigned, wherein the number of tokens is above a threshold value. Recall that more than one detection by the LMDU of address aliasing between the load address and a store address of a previously issued store instruction can occur. While a number of address aliasing detections can be handled by the LMDU, and the number of detections increases, satisfying the load instructions can become problematic because of the length of delay to process one or more load instructions, data dependencies, and so on. The load tokens can be assigned, and the load instructions satisfied while the number of load tokens remains at or below the threshold. Once the threshold has been exceeded, various techniques can be applied. The flow 200 can further include rejecting 240, by the LMDU, the load instruction. The rejecting can include indicating to the compute slice executing a load instruction in the compute slice task that the load instruction has not been loaded into the MOT within the LMDU. The rejecting can cause the compute slice to pause execution of the compute slice task.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

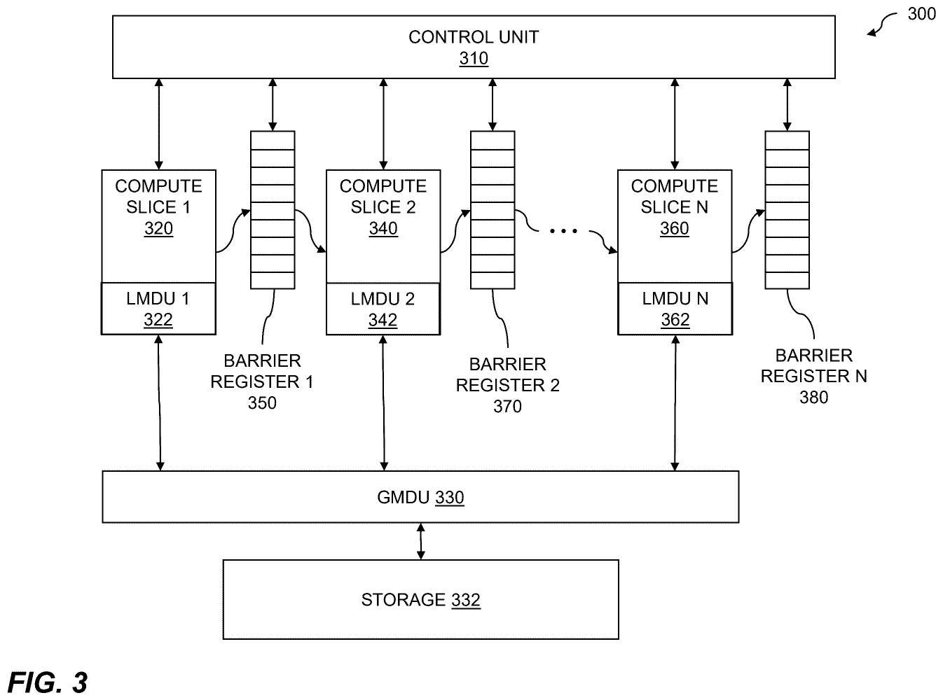

FIG. 3 is a block diagram for a compute slice and load store unit control. A processing unit can be used to process data for applications such as image processing, audio and speech processing, artificial intelligence and machine learning, and so on. The processing unit can include a variety of elements, where the elements include compute slices; a control unit; a plurality of local memory disambiguation units (LMDUs); a memory system; busing, switching, and networking; and the like. In embodiments, each compute slice within the plurality of compute slices includes at least one execution unit. Each compute slice is coupled to an LMDU. The compute slices can obtain data for processing. The data can be obtained from the memory system, cache memory, a scratchpad memory, register files, etc. The compute slices can be coupled in a ring configuration, where each compute slice can be coupled to a predecessor and a successor compute slice using a barrier register. A compute slice can only write to a barrier register between it and the successor compute slice, and a successor compute slice can only read from the barrier register. The control unit can control data access, data processing, etc. by the compute slices.

Compute slice control enables local memory disambiguation for a parallel architecture with compute slices. A processing unit is accessed, comprising a plurality of compute slices, a control unit, a plurality of local memory disambiguation units (LMDUs), and a memory system. Each compute slice within the plurality of compute slices includes at least one execution unit and is coupled to a successor compute slice and a predecessor compute slice. Each compute slice within the plurality of compute slices is coupled to an LMDU in the plurality of LMDUs. The control unit distributes a first slice task to a first compute slice within the plurality of compute slices. The first compute slice is coupled to a first LMDU within the plurality of LMDUs. The first compute slice executes the first slice task, wherein the first slice task includes a load instruction. The load instruction includes a load address. The first compute slice issues a load instruction to the first LMDU. The issuing includes saving, in a memory operation table (MOT) within the LMDU, load information associated with the load instruction. The LMDU detects address aliasing between the load address and a store address of a previously issued store instruction. The detecting is based on the MOT. The MOT forwards store information from the previously issued store instruction. The store information satisfies one or more bytes of data required for the load instruction.

Compiled programs can comprise a plurality of slice tasks, where the slice tasks can be executed on a processing unit. The processing unit can include compute slices, where the compute slices can enable a parallel processing architecture. Some slice tasks associated with the program can be executed in parallel, while others must be properly sequenced. The sequential execution and the parallel execution of the slice tasks are dictated in part by the existence of or absence of data dependencies between slice tasks. In a usage example, compute slice A, running slice task A, processes input data and produces output data that is required by compute slice B, running slice task B. Each compute slice is coupled to a local memory disambiguation unit (LMDU). For correct results, slice task A must first generate the input required by slice task B before slice task B can fully execute on compute slice B. In embodiments, slice task B can execute speculatively, wherein the speculative execution does not depend on inputs from slice task A. When slice B execution gets to the point where it depends on input from slice A, compute slice B can stall while waiting for results from the predecessor slice. Once the results are obtained, compute slice B can continue to execute slice task B speculatively while slice task A proceeds. Compute slice C, however, holds slice task C which executes instructions that process the same input data as slice task A, and also produces its own output data. Thus, slice task C can be speculatively executed in parallel with slice tasks A and B.

The execution of tasks such as slice tasks can be based on memory access operations, where the memory access operations include data loads from memory, data stores to memory, load-modify-store operations, and so on. Some of the slice tasks can share data, provide processed data to other slice tasks, and the like. To continue the usage example above, slice task B executing on compute slice B can include a load instruction that includes a load address. The load instruction can be issued to the first LMDU associated with slice B. The issuing can include saving load information. The load information can be saved in a memory operation table (MOT) within the LMDU. The LMDU can detect address aliasing between the load address and a store address of a previously issued store instruction within the same slice B. Store information from the previously issued store instruction can be forwarded by the MOT. The forwarding can be performed when the store information satisfies one or more bytes of data required for the load instruction. That is, previously stored information generated by slice task B can be forwarded to a load also executing on slice B without having to first store information to a cache or memory system before loading. In embodiments, a GMDU can detect aliasing between a previously executed store on slice task A and a load instruction that is executed on slice task B.

The block diagram 300 can include a control unit 310 within the processing unit. The control unit can be used to control one or more compute slices, barrier registers, LMDUs, and so on associated with the processing unit. The control unit can operate based on receiving a set of slice tasks from a compiler. The compiler can include a high-level compiler, a hardware language compiler, a compiler developed for use with the processing unit, and so on. The control unit can distribute and allocate slice tasks to compute slices associated with the processing unit. The control unit can be used to commit a result of a slice task to a barrier register as the slice task is executing, or when execution of the slice task has been completed. The control unit can perform checking and control operations. The checking and control operations can include checking that a slice task is a next sequential slice task in a compiled program; distributing slice tasks; canceling slice tasks; moving a head pointer and a tail pointer; allowing a compute slice to commit results to memory; and so on. The control unit can perform state assignment operations. Embodiments include assigning, by the control unit, a state to each compute slice in the plurality of compute slices, wherein the state is one of idle, executing, holding, or done. The assigned states can be used to determine whether a compute slice is ready to receive a slice task, data is ready to be committed, etc. The state of a compute slice can be used for exception handling techniques. The exception handling techniques can be associated with nonrecoverable exceptions and recoverable exceptions, interrupts, etc.

The processing unit can include a plurality of compute slices. The compute slices can be issued, by the control unit, slice tasks for execution. The slice tasks can include blocks of code associated with a compiled program generated by the compiler. In the figure, the compute slices include compute slice 1 320, compute slice 2 340, and compute slice N 360. The number of compute slices that can be included in the processing unit can be based on a processing architecture, a number of processor cores on an integrated circuit or chip, and the like. A local memory disambiguation unit (LMDU) can be included in each compute slice. The LMDU can be used to provide load data obtained from a memory system for processing on the associated code slice. The LMDU can be used to hold store data generated by the compute slice and can be designated for storing in the memory system. The LMDU can detect address aliasing between a load address and a store address of a previously issued store instruction. The LMDUs can include LMDU 1 322 included in compute slice 1 320; LMDU 2 342 included in compute slice 2 340; and LMDU N 362 included in compute slice N 360. The detecting can be based on a memory operation table (MOT) within the LMDU. The MOT can forward store information, from the previously issued store instruction, to one or more bytes of information that satisfy data requirements for the load instruction. As the number of compute slices changes for a particular processing unit architecture, the number of LMDUs can change correspondingly.

The LMDUs can be coupled to a global memory disambiguation unit (GMDU) 330. The GMDU can “look across” all of the LMDUs to perform global alias checking against the load instruction. That is, the data requested by the load instruction may be present in one of the other LMDUs. The GMDU can also provide requested data that is not present in an LMDU. The GMDU can be coupled to an element within one or more storage elements 332. The storage elements can include cache such as a data cache (not shown), a memory system (not shown), and so on. In embodiments, the memory system can include a global memory disambiguation unit (GMDU). Each LMDU in the plurality of LMDUs is coupled to the GMDU. The cache can include a single-level cache, a multi-level cache, etc. The memory system can include a shared memory system, where the shared memory system can be shared between or among two or more processing units. Additional load instructions can be issued. Embodiments include rejecting, by the LMDU, the load instruction. The load instruction can be rejected, and executed at a later time, because the requested load data is not available, not yet complete, etc.

The communication between the LMDUs and the GMDU can include sending a load instruction to the GMDU. In embodiments, the issuing the load instruction includes sending, to the first LMDU, the load instruction to the GMDU. The sending can be accomplished using a bus, a network, and so on. Further embodiments can include marking, by the memory operation table, the load instruction as issued. The marking can prevent duplication of sending the load request. The GMDU can perform various operations on the load instruction. Embodiments can include performing, by the GMDU, global alias checking against the load instruction. The global alias checking can include checking one or more other LMDUs in the plurality of LMDUs. The alias checking can check an aliased load instruction and a previously issued store instruction. Recall that when the detecting does detect address aliasing between the load instruction and the previous store instruction, the store information can be forwarded by the MOT to the load instruction. The forwarded information can include one or more bytes, but may not include all information bytes requested by the load instruction. Further embodiments can include providing, by the GMDU, the load instruction with one or more additional bytes of data required for the load instruction. Thus, information that is not present in the MOT may be provided by the GMDU. If the information is not present in the GMDU, then the information can be sought in a cache, the memory system, etc.

The processing unit depicted in block diagram 300 can include a plurality of sets of barrier registers. The barrier registers can be used to hold load data to be processed by a compute slice, to receive store data generated by a compute slice, and so on. In embodiments, a second compute slice can be coupled to a first compute slice by a first barrier register set in the plurality of barrier register sets. In the block diagram, barrier register 1 350 can couple compute slice 2 340 to compute slice 1 320, barrier register 2 370 can couple compute slice 3 (not shown) to compute slice 2 340, barrier register N 380 can couple compute slice N+1 (not shown) to compute slice N 360, etc. Slice tasks can be issued to compute slices in an order. In the block diagram 300, this order can be visualized as from left to right. That is, a left-hand compute slice or predecessor compute slice only has to write to a barrier register coupled to a right-hand compute slice or successor. A successor compute slice does not have to write to a predecessor compute slice, nor does a predecessor compute slice have to read from a successor compute slice. In an implementation example, a successor compute slice can be to the left or the right of its predecessor. In further embodiments, the plurality of compute slices and the plurality of barrier register sets can be coupled in a ring configuration. Thus, barrier register N 380 can be coupled between compute slice N 360 and compute slice 1 320.

Data movement to, from, and within the processing unit, whether loading, storing, transferring, etc., can be accomplished using a variety of techniques. In embodiments, memory system access operations can be performed outside of processing unit, thereby freeing the compute slices within the processing unit to execute slice tasks. Memory access operations, such as autonomous memory operations, can preload data needed by one or more compute slices. The preloaded data can be placed in buffers associated with compute slices that require the data. In additional embodiments, a semi-autonomous memory copy technique can be used for transferring data. The semi-autonomous memory copy technique can be accomplished by the processing unit which generates source and target addresses required for the one or more data moves. The processing unit can further generate a data size such as 8, 16, 32, or 64-bit data sizes, and a striding value. The striding value can be used to avoid overloading a column of storage components such as a cache memory.

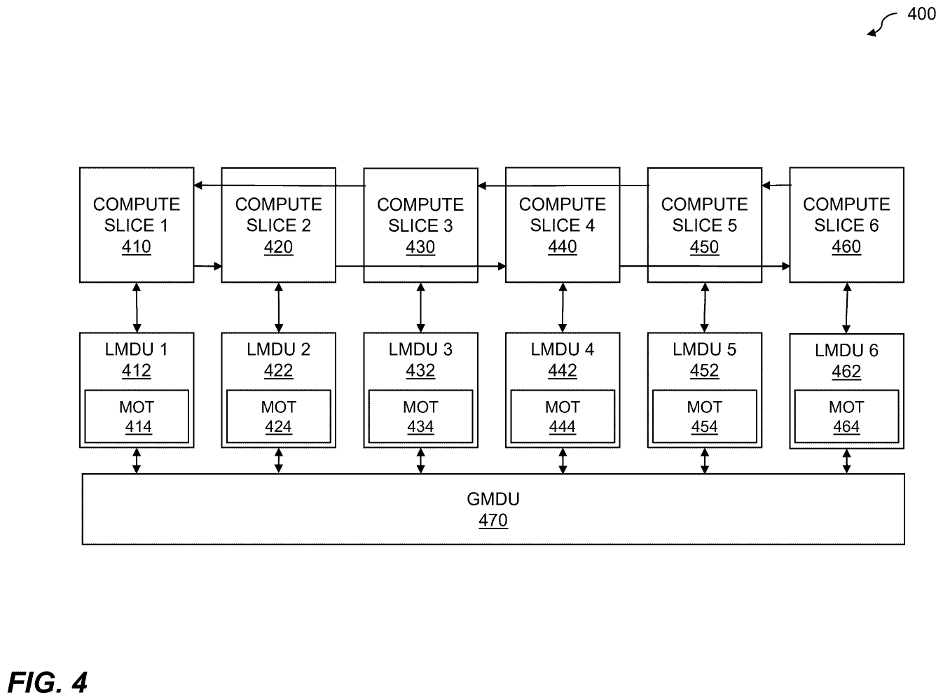

FIG. 4 is a block diagram for a ring configuration of compute slices and local memory disambiguation units (LMDUs). Described previously and throughout, a processing unit can be used to execute a compiled program. The program can be associated with processing applications such as image processing, audio processing, and natural language processing applications. The processing can be associated with artificial intelligence applications such as machine learning. The processing unit can include various elements such as compute slices and local memory disambiguation units (LMDUs). Each compute slice can independently execute a block of code called a slice task. The slice tasks that can be associated with the compute slices can be associated with a compiled program. The execution of the slice tasks can be controlled by a local program counter associated with each compute slice. Communication between a compute slice and its immediate neighbors, such as a predecessor compute slice and a successor compute slice, is accomplished using a barrier register set. A current compute slice is not required to write to a predecessor compute slice, nor to read from a successor compute slice.

The ring configuration of compute slices and local memory disambiguation units enables local memory disambiguation for a parallel architecture with compute slices. A processing unit is accessed, comprising a plurality of compute slices, a control unit, a plurality of local memory disambiguation units (LMDUs), and a memory system. Each compute slice within the plurality of compute slices includes at least one execution unit and is coupled to a successor compute slice and a predecessor compute slice. Each compute slice within the plurality of compute slices is coupled to an LMDU in the plurality of LMDUs. The control unit distributes a first slice task to a first compute slice within the plurality of compute slices. The first compute slice is coupled to a first LMDU within the plurality of LMDUs. The first compute slice executes the first slice task. The first slice task includes a load instruction, and the load instruction includes a load address. The first compute slice issues the load instruction to the first LMDU. The issuing includes saving, in a memory operation table (MOT) within the LMDU, load information associated with the load instruction. The LMDU detects address aliasing between the load address and a store address of a previously issued store instruction. The detecting is based on the MOT. The MOT forwards store information from the previously issued store instruction, wherein the store information satisfies one or more bytes of data required for the load instruction.

The block diagram 400 shows a ring configuration of compute slices. The compute slices within the ring configuration can include compute slice 1 410, compute slice 2 420, compute slice 3 430, compute slice 4 440, compute slice 5 450, compute slice 6 460, and so on. While six compute slices are shown, the ring of compute slices can also comprise more or fewer compute slices. The compute slice ring configuration can be accomplished using an integrated circuit or chip, a plurality of compute slice cores, a configurable chip such as an FPGA or ASIC, and the like. The ring configuration can be based on a regularized circuit layout, equalized interconnect lengths, and so on. Each compute slice, such as compute slice 3 430, can be coupled to a successor compute slice, such as compute slice 1 410, and a predecessor compute slice, such as compute slice 5 450. The coupling can include a barrier register set such as a barrier register set described previously. In a usage example, the compute slice 3 430 can only write to the barrier register and compute slice 1 410 can only read from the barrier register. This architectural technique can ensure that a compute slice that requires input data from a predecessor compute slice can read valid data. That is, the current compute slice generates data, branch decisions, etc., and writes the generated data and branch decision information to the input of the barrier register while the output of the register remains unchanged. The data being read at the output of the barrier register will remain valid while the successor compute slice is processing data. The results from the first compute slice can be sent to the barrier register set immediately, and thus can be available to the next compute slice on the following cycle. The committing of data to the output of the barrier register set is performed by the control unit. This technique eliminates a race condition such as a write-before-read race condition.

Each of the compute slices can include at least one LMDU from a plurality of LMDUs. A compute slice can execute a first slice task distributed by the control unit to the compute slice. A compute slice can issue a load instruction to a first LMDU, based on the compute slice executing the first slice task. The issuing can include saving load information associated with the load instruction in a memory operation table (MOT) within the LMDU. The load instruction includes a load address. The LMDU can detect address aliasing between the load address and a store address of a previously issued store instruction. The detecting address aliasing can be accomplished using the MOT within the LMDU. The MOT can forward store information comprising one or more bytes of data from the previously issued store instruction, where the store information satisfies data required by the load instruction. In the block diagram 400, compute slice 1 410 includes LMDU 1 412, compute slice 2 420 includes LMDU 2 422, compute slice 3 430 includes LMDU 3 432, compute slice 4 440 includes LMDU 4 442, compute slice 5 450 includes LMDU 5 452, and compute slice 6 460 includes LMDU 6 462. While six LMDUs are shown, more or fewer LMDUs can be included, according to the number of compute slices in the processing unit. Noted above, each LMDU includes a memory operation table (MOT). In the block diagram 400, LMDU 1 includes MOT 414, LMDU 2 includes MOT 424, LMDU 3 includes MOT 434, LMDU 4 includes MOT 444, LMDU 5 includes MOT 454, LMDU 6 includes MOT 464. Each LMDU can be coupled between its corresponding compute slice and a global memory disambiguation unit (GMDU).

Noted above, the MOT can forward store information from a previous store instruction. At times, the load information required by the load operation is not entirely satisfied by the store information, so the MOT is not able to fully forward the required data for the load instruction. Thus, load data required by the load instruction must be accessed in a shared cache, a shared memory system, and so on. In embodiments, the required load data can be located in another LMDU within the plurality of LMDUs. The block diagram 400 includes a global memory disambiguation unit (GMDU) 470. Each LMDU in the plurality of LMDUs is coupled to the GMDU. The GMDU can “look across” the plurality of LMDUs to determine whether required data is available in one of the other LMDUs. In embodiments, the issuing can include sending, by the first LMDU, the load instruction to the GMDU. The GMDU can examine an address associated with the load instruction and can perform global alias checking. Embodiments can include performing, by the GMDU, global alias checking against the load instruction. The global alias checking can include one or more other LMDUs in the plurality of LMDUs. One of the other LMDUs can include the requested data that is not available in the first LMDU. Further embodiments can include providing, by the GMDU, the load instruction with one or more additional bytes of data required for the load instruction.

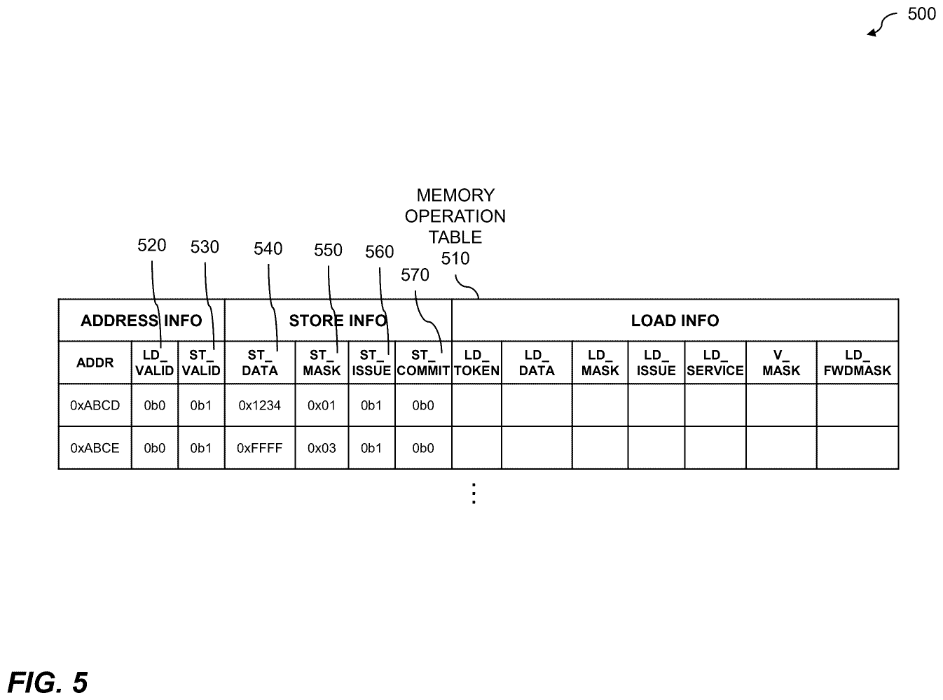

FIG. 5 is a first example of forwarding data. The forwarding of data can be accomplished by using a memory operation table (MOT). The MOT can forward store information from a previously issued store instruction where the information satisfies one or more bytes of data required for the load instruction. The forwarding data is based on local memory disambiguation for a parallel architecture with compute slices. The first example 500 shows a memory operation table 510. The MOT can include three types of information, where the information includes address information, store information, and load information. Each type of information can include one or more fields. The table below shows an example of information types and fields.

TABLE 1
Information types, field names, and field meanings.

| INFO TYPE | FIELD NAME | MEANING |
|---|---|---|
| ADDRESS | ADDR | ADDRESS |
| | LD_VALID | Load valid |
| | ST_VALID | Store valid |
| STORE | ST_DATA | Store data |
| | ST_MASK | Store mask |
| | ST_ISSUE | Store issued |
| | ST_COMMIT | Store committed |
| LOAD | LD_TOKEN | Load token |
| | LD_DATA | Load data |
| | LD_MASK | Load mask |
| | LD_ISSUE | Load issued |
| | LD_SERVICE | Load serviced |
| | V_MASK | Valid mask |
| | LD_FWDMASK | Load forward data mask |

The example 500 shows a first example of forwarding data. A memory operation table (MOT) 510 is shown, where the MOT includes address information, store information, and load information. One or more fields are associated with each type of information. In the example, two previously executed stores have been processed and have been stored in the MOT. The previously executed store operations, in this example, were issued by a local memory disambiguation unit (LMDU). The store operations have not yet been committed to memory. Further, all fields associated with load information remain null. The load operation fields remain null because the operations are store operations rather than load operations.

Each store operation includes address information and store information. The address information can include an address such as 0xABDC and 0xABCE. The address information further includes a load valid 520 entry and a store valid 530 entry. Since the operations in the MOT are store operations, the load valid 520 bits are set to zero, and the store valid 530 bits are set to 1. The store information associated with the two store operations includes further fields. The store information fields include store data, a store mask bit, a store issue bit, and a store commit bit. The store information includes the store data 540 associated with each store command. The store mask 550 indicates which one of the one or more bytes of a maximum number of possible bytes will be stored. The number of bytes can include 2, 4, 8, or 16 bytes, and so on. The store issue bit 560 can indicate whether the store operation has been issued to the GMDU. In this example, each store operation was issued by the GMDU. The store commit bit 570 is used to indicate when the masked store data has been committed to memory such as system memory. In the example, the data associated with either store operation has not been committed to memory.

At any point, another store instruction to the same address can be issued by the LMDU. When this occurs, the new store instruction can be coalesced with the store instruction that is already saved in the MOT. When a new store instruction is executed by compute slice and sent to the LMDU, the old store information can be overwritten by the new store instruction. The data that is written by the new store instruction can be masked by the store mask 550. That is, only the valid bits of the new store data are overwritten in the MOT and the store mask can be updated accordingly. The store issued bit can then be reset, indicating that new store information must be sent to the GMDU. Finally, the GMDU can be sent the new store information so that it can be written to memory. In embodiments, the executing includes a second store instruction, wherein the second store instruction is associated with the load address. Further embodiments include coalescing, in the LMDU, new store information associated with the second store instruction, with the store information.

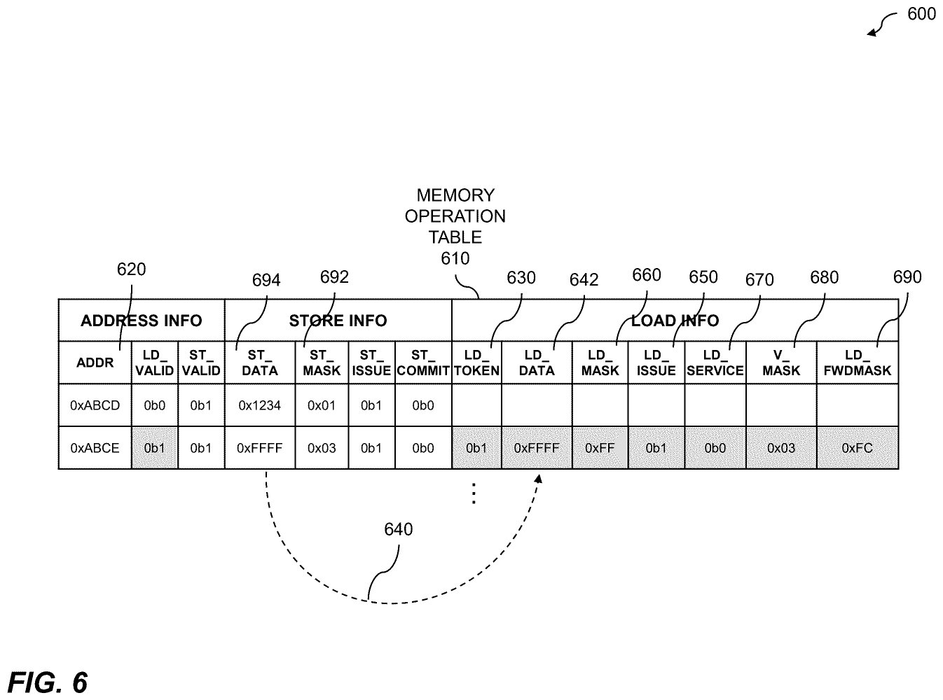

FIG. 6 is a second example of forwarding data. In the second example 600, a memory operation table (MOT) 610 is shown with store information associated with two store operations discussed previously. A current compute slice can execute a load operation. In this example, the load operation executed by the current compute slice issues the load instruction to a local memory disambiguation unit (LMDU) and saves load information in the MOT associated with the LMDU. In the example, the load information includes a load address 620, 0xABCE that matches a store address previously saved in the MOT. The load operation can be assigned a load token 630, where the load token can include one or more bits. In embodiments, the load token can include 32 bits. Since data from the previously executed store operation satisfies one or more bytes of data required by the load operation, the data can be immediately forwarded 640 to the LD-DATA 642 to satisfy, at least in part, the load operation. Further to forwarding data, the load instruction is forwarded to the global memory disambiguation unit (GMDU). Forwarding the load operation can be indicated by setting a load issue bit LD_ISSUE 650.

Recall that the address information and the store information each have one or more information fields. The load information similarly can have one or more fields. The fields associated with the load information are shown in Table 1 above. The load information fields can include a load token LD_TOKEN 630, load data LD_DATA 642, a load mask LD_MASK 660, load issued LD_ISSUE 650, load serviced LD_SERVICE 670, a valid mask V_MASK 680, and a load forward mask LD_FWDMASK 690. The LD_FWDMASK 690 is the complement of the V_MASK 680. Note that in the example, the store mask ST_MASK 692 is 0x03. The store mask can be used to indicate which bytes of store data ST_DATA 694 are valid and can be loaded. That is, for the ST_DATA=0xFFFF, only bytes 1 and 3 are valid for loading. Since the load mask LD_MASK=0xFF, all data bytes are required for the load instruction. Additional valid load data bytes can be obtained from the GMDU. Which bytes are required for loading can be indicated by a load forward mask LD_FWDMASK 690. As previously mentioned, the LD_FWDMASK 690 is the complement of a valid mask V_MASK. Since in the example, V_MASK=0x03, then LD_FWDMASK=0xFC. The LD_FWDMASK 690 can indicate the remaining valid data bytes that are required by the load instruction. The remaining needed data can be obtained by the GMDU.

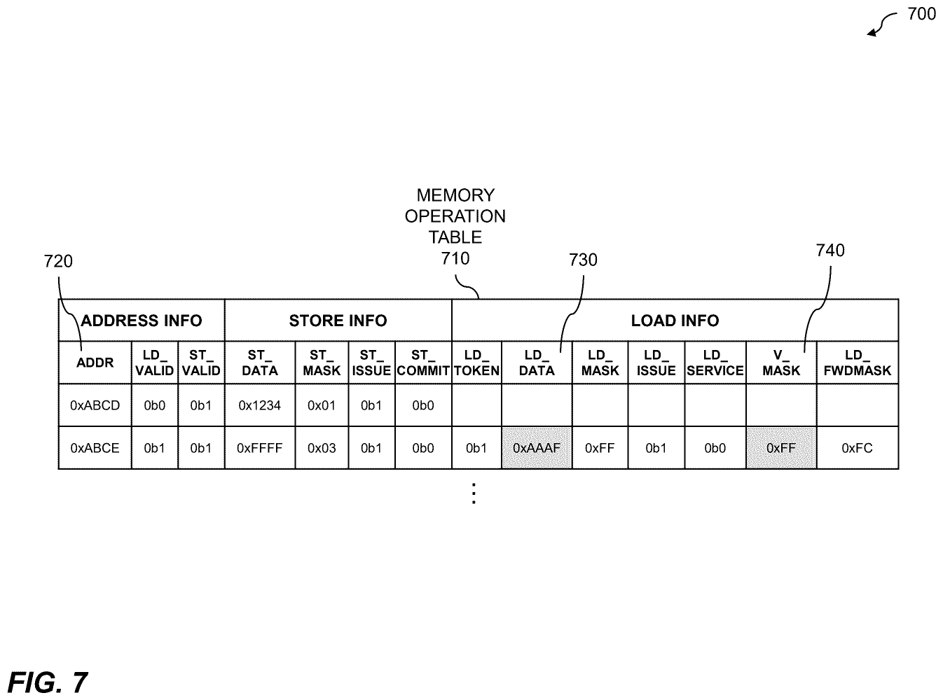

FIG. 7 is a third example of forwarding data. Data requested by a load instruction associated with a slice task executing on a compute slice can be provided from various sources. Discussed previously and throughout, some or all of the data required by the load operation may be available in a memory operation table (MOT) within a local memory disambiguation unit (LMDU) in the compute slice. The requested load data may in part or in whole be available from a previously executed store instruction within the same LMDU. In the third example 700, a memory operation table (MOT) 710 is shown with store information associated with two store operations discussed previously. A current compute slice executes a load operation, where the load operation issues the load instruction to the local memory disambiguation unit (LMDU) and saves load information in the MOT within the LMDU. The load operation is requesting data from an address also associated with one of the store operations. In this example of forwarding data, the load information includes a load address 720 0xABCE, that matches a store address previously saved in the MOT. In example 600, data was forwarded from a previously executed store instruction to the load instruction to the same address. However, the mask indicated that load instruction required additional data. In this example, the additional data is obtained from the GMDU. The full load data LD_DATA 730 is 0xAAAF, and the valid mask V_MASK 740 is set to 0xFF. The V_MASK 740 value indicates that all bytes are valid and are ready to be sent back to the compute slice. A token associated with a particular load operation can be released when the load is satisfied.

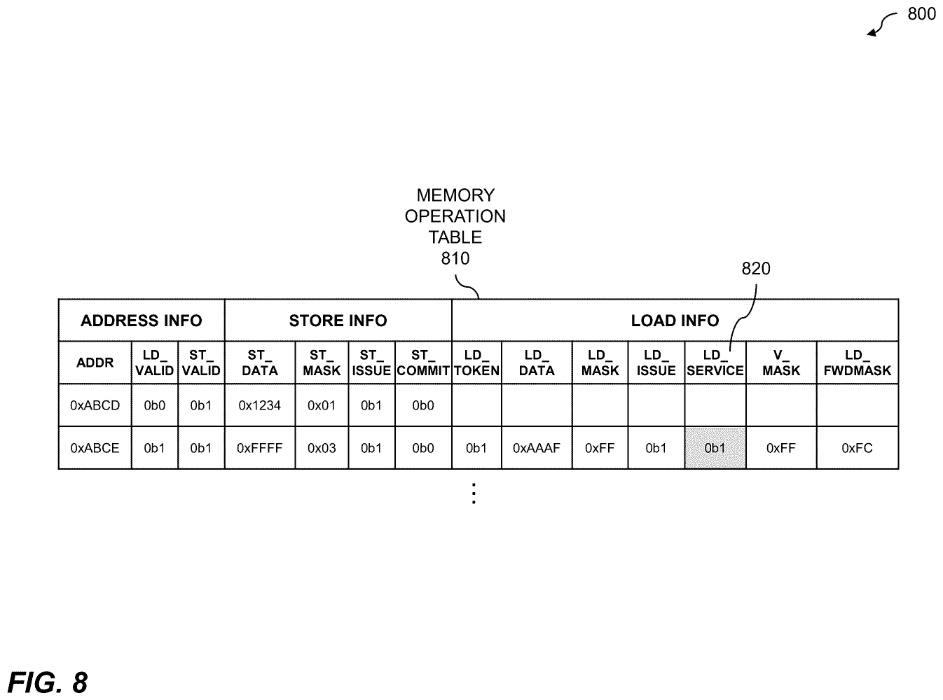

FIG. 8 is a fourth example of forwarding data. Data requested by a load operation has been provided by the GMDU as described previously. In the example 800, the data can now be sent back to the compute slice that issued the load operation. The sending back the data can be indicated by a load service LD_SERVICE 820 bit being set to 0b1 in the memory operation table (MOT) 810.

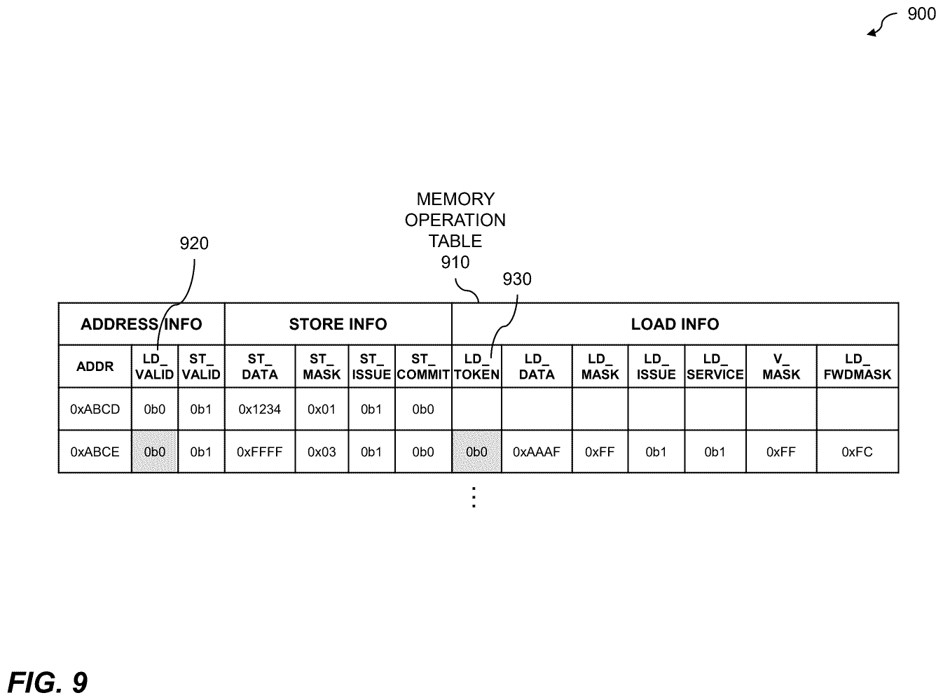

FIG. 9 is a fifth example of forwarding data. Discussed in the previous example, a load operation can be serviced. In the example 900, the LD_VALID 920 bit associated with an address row in the memory operation table (MOT) 910 can be reset or deactivated. Deactivating the LD_VALID 920 bit can allow the space within the MOT to be reclaimed for another load instruction that accesses a given address such as 0xABCE. In addition to deactivating the valid bit, the load token 930 can also be released.

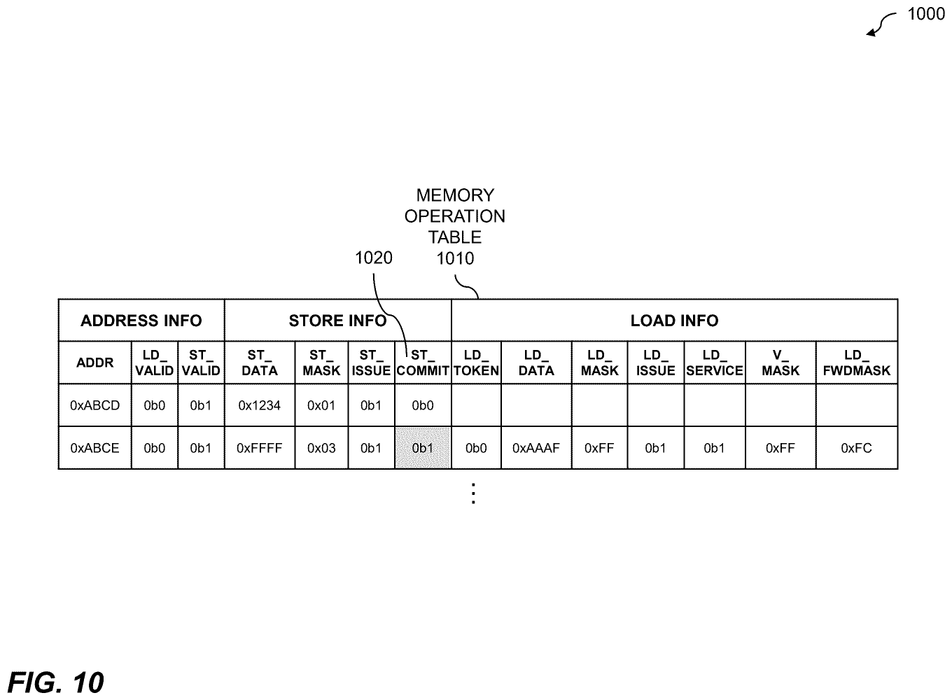

FIG. 10 is a sixth example of forwarding data. In the example 1000, at some point in the execution of store operations associated with a slice task executing on a compute slice, data associated with a store operation can be written to a memory such as a shared system memory. The writing to memory is accomplished by a global memory disambiguation unit (GMDU). The operation of committing the data to the memory can be communicated to a local memory disambiguation unit (LMDU). The communicating to the LMDU can be accomplished by setting a store commit (ST_COMMIT 1020) bit associated with the store operation. The ST_COMMIT 1020 bit is a field within the memory operation table (MOT) 1010. The ST_COMMIT 1020 bit can be set to 0b1.

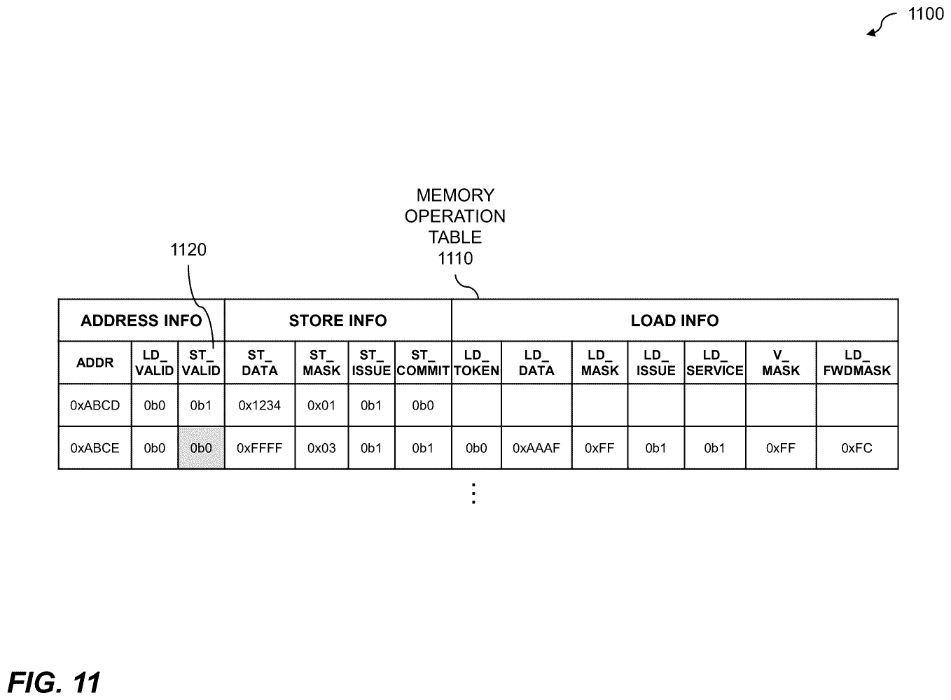

FIG. 11 is a seventh example of forwarding data. In the example 1100, the store operation has been completed as discussed above. The completing the store operation is accomplished by committing data associated with the store operation to a memory such as a shared memory. Having completed the store operation, the ST_VALID 1120 field bit in the address information associated with a row within the memory operation table (MOT) 1110 can be reset. Resetting the ST_VALID 1120 bit can free up the row in the MOT associated with the store address. The freed row can be used for a new set of memory address tracking.

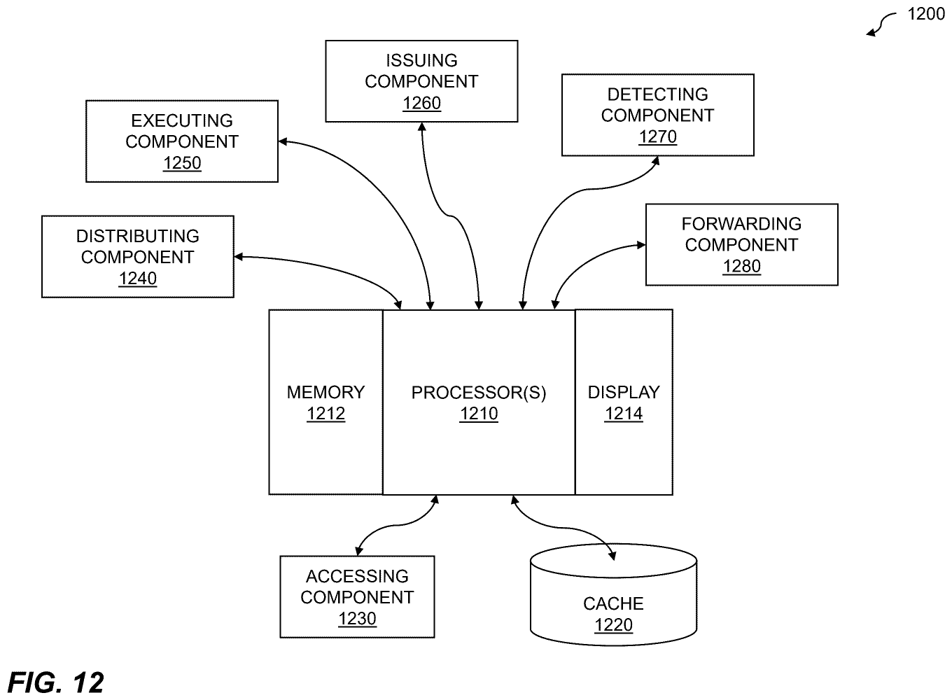

FIG. 12 is a system diagram for local memory disambiguation for a parallel architecture with compute slices. The system 1200 can include one or more processors 1210, which are coupled to a memory 1212 which stores instructions. The system 1200 can further include a display 1214 coupled to the one or more processors 1210 for displaying data; intermediate steps; slice tasks; topologies including systolic, vector, cyclic, spatial, streaming, or VLIW topologies; and so on. In embodiments, one or more processors 1210 are coupled to the memory 1212, wherein the one or more processors, when executing the instructions which are stored, are configured to: access a processing unit comprising a plurality of compute slices, a control unit, a plurality of local memory disambiguation units (LMDUs), and a memory system, wherein each compute slice within the plurality of compute slices includes at least one execution unit, and is coupled to a successor compute slice and a predecessor compute slice, wherein each compute slice within the plurality of compute slices is coupled to an LMDU in the plurality of LMDUs; distribute, by the control unit, a first slice task to a first compute slice within the plurality of compute slices, wherein the first compute slice is coupled to a first LMDU within the plurality of LMDUs; execute, by the first compute slice, the first slice task, wherein the first slice task includes a load instruction, and wherein the load instruction includes a load address; issue, by the first compute slice, the load instruction to the first LMDU, wherein the issuing includes saving, in a memory operation table (MOT) within the LMDU, load information associated with the load instruction; detect, by the LMDU, address aliasing between the load address and a store address of a previously issued store instruction, wherein the detecting is based on the MOT; and forward, by the MOT, store information from the previously issued store instruction, wherein the store information satisfies one or more bytes of data required for the load instruction. The compute slices can include compute slices within one or more integrated circuits or chips; compute slices or cores configured within one or more programmable chips such as application specific integrated circuits (ASICs); field programmable gate arrays (FPGAs); heterogeneous processors configured as a mesh; standalone processors; etc.

The system 1200 can include a cache 1220. The cache 1220 can be used to store data such as scratchpad data, slice tasks for compute slices, memory operation tables, intermediate results, microcode, branch decisions, and so on. The cache can comprise a small, local, easily accessible memory available to one or more compute slices. In embodiments, the data that is stored can include operations, data, and so on. The system 1200 can include an accessing component 1230. The accessing component 1230 can include control logic and functions for accessing a processing unit. The processing unit can be accessible within an integrated circuit, an application-specific integrated circuit (ASIC), a programmable unit such as a field-programmable gate array (FPGA), and so on. The processing unit can comprise a plurality of compute slices, a control unit, a plurality of local memory disambiguation units (LMDUs), and a memory system.

Each compute slice within the plurality of compute slices includes at least one execution unit. A compute slice can include one or more processors, processor cores, processor macros, processor cells, and so on. Each compute slice can include an amount of local storage. The local storage may be accessible by one or more compute slices. The compute slices can be organized in a ring. Compute slices within the ring can be accessed using pointers. The pointers can include a head pointer, a tail pointer, and the like. Each compute slice is coupled to a successive compute slice and a predecessor compute slice by a barrier register set in the plurality of barrier register sets. The barrier register set provides for communication of data between successive compute slices. Communication between and among compute slices can be accomplished using a bus such as an industry standard bus, a ring bus, a network such as a wired or wireless computer network, etc. In embodiments, the ring bus is implemented as a distributed multiplexor (MUX). Each compute slice within the plurality of compute slices is coupled to an LMDU in the plurality of LMDUs. Discussed below, the LMDUs can hold one or more store instructions, one or more load instructions, and so on. The LMDUs can access a memory system. In embodiments, the memory system can include a global memory disambiguation unit (GMDU), and each LMDU in the plurality of LMDUs is coupled to the GMDU. Discussed below, the GMDU can “look across” the plurality of LMDUs for address aliasing associated with store instructions and load instructions.

The system 1200 can include a distributing component 1240. The distributing component 1240 can include control and functions for distributing, by the control unit, a first slice task to a first compute slice within the plurality of compute slices, wherein the first compute slice is coupled to a first LMDU within the plurality of LMDUs. The distributing can be accomplished using pointers. The pointers can be initialized to indicate a first compute slice, a second compute slice, and so on. Embodiments can further include initializing pointers. A head pointer points to the first compute slice, and a tail pointer points to the second compute slice. The slice task can include a task that is running speculatively or running non-speculatively. In embodiments, the head pointer points to a slice task that is running non-speculatively. The first slice task includes a load instruction. The distributing can be accomplished using a bus, a network such as a network-on-chip (NOC), and so on. The distributing is accomplished by the control unit. The distributing the first slice task for the first compute slice can be accomplished when the first compute slice is the head slice. The head slice can be a state within the control unit and can point to the first compute slice running a slice task non-speculatively.

The system 1200 can include an executing component 1250. The executing component 1250 can include control and functions for executing, by the first compute slice, the first slice task. The first slice task includes a load instruction, and the load instruction includes a load address. The load instruction can initiate a memory access operation. The memory access operation can be handled by the LMDU, by the GMDU, and so on. In embodiments, executing can include allocating, to the load instruction, a load token. The load token can include one or more bits. In embodiments, the load token includes between 1 and 32 bits. The load token can be used to track multiple load operations that request data from the same memory address. In embodiments, the executing can include a second load instruction, wherein the second load instruction includes the load address. The second load instruction can be accepted or rejected for execution. Further embodiments can include rejecting, by the LMDU, the load instruction. The load instruction can be rejected for a variety of reasons such as when the store data to which the load instruction refers has not yet been committed to memory. In other embodiments, the executing can include a second store instruction, wherein the second store instruction is associated with the load address. Storing data to an address required by a load instruction can create a race condition or memory access hazard. Further embodiments can include coalescing, in the LMDU, new store information associated with the second store instruction, with the previous store information.

The system 1200 can include an issuing component 1260. The issuing component 1260 can include control and functions for issuing, by the first compute slice, the load instruction to the first LMDU, wherein the issuing includes saving, in a memory operation table (MOT) within the LMDU, load information associated with the load instruction. Discussed previously and throughout, the MOT can include various types of information such as address information, store information, load information, and so on. A row within the MOT can include one or more of a store operation, a load operation, and so on. The issuing can add a row to the MOT where the row includes address information and load information associated with the load instruction. If the address accessed by the load instruction has an assigned row due to a previously executed load or store operation, then the load instruction load information is added to an existing row.

The system 1200 can include a detecting component 1270. The detecting component 1270 can include control and functions for detecting, by the LMDU, address aliasing between the load address and a store address of a previously issued store instruction. The detecting is based on the MOT. The detecting can be used to determine whether some or all of the store data previously placed in the MOT matches data requested by the load operation. A load mask (discussed previously) can be used to indicate an amount of data such as how many bytes of data are required by the load instruction. For situations in which data bytes requested by the load instruction are not available from the store instruction, the load instruction can obtain further data via the GMDU. The GMDU can look across the other LMDUs to determine whether the required data is available and valid. If not, the data can be obtained by accessing memory.

The system 1200 can include a forwarding component 1280. The forwarding component 1280 can include control and functions for forwarding, by the MOT, store information from the previously issued store instruction, wherein the store information satisfies one or more bytes of data required for the load instruction. Discussed above, the one or more bytes of data associated with the previously issued store instruction can include some or all of the bytes of data required by the load instruction. When the forwarded bytes do not fully satisfy the load data requirements, the remaining bytes can be obtained from the GMDU.

The system 1200 can include a computer program product embodied in a non-transitory computer readable medium for checking memory operations, the computer program product comprising code which causes one or more processors to generate semiconductor logic for: accessing a processing unit comprising a plurality of compute slices, a control unit, a plurality of local memory disambiguation units (LMDUs), and a memory system, wherein each compute slice within the plurality of compute slices includes at least one execution unit, and is coupled to a successor compute slice and a predecessor compute slice, wherein each compute slice within the plurality of compute slices is coupled to an LMDU in the plurality of LMDUs; distributing, by the control unit, a first slice task to a first compute slice within the plurality of compute slices, wherein the first compute slice is coupled to a first LMDU within the plurality of LMDUs; executing, by the first compute slice, the first slice task, wherein the first slice task includes a load instruction, and wherein the load instruction includes a load address; issuing, by the first compute slice, the load instruction to the first LMDU, wherein the issuing includes saving, in a memory operation table (MOT) within the LMDU, load information associated with the load instruction; detecting, by the LMDU, address aliasing between the load address and a store address of a previously issued store instruction, wherein the detecting is based on the MOT; and forwarding, by the MOT, store information from the previously issued store instruction, wherein the store information satisfies one or more bytes of data required for the load instruction.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include
computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for checking memory operations comprising:
accessing a processing unit comprising a plurality of compute slices, a control unit, a plurality of local memory disambiguation units (LMDUs), and a memory system, wherein each compute slice within the plurality of compute slices includes at least one execution unit, and is coupled to a successor compute slice and a predecessor compute slice, wherein each compute slice within the plurality of compute slices is coupled to an LMDU in the plurality of LMDUs;
distributing, by the control unit, a first slice task to a first compute slice within the plurality of compute slices, wherein the first compute slice is coupled to a first LMDU within the plurality of LMDUs;
executing, by the first compute slice, the first slice task, wherein the first slice task includes a load instruction, and wherein the load instruction includes a load address;
issuing, by the first compute slice, the load instruction to the first LMDU, wherein the issuing includes saving, in a memory operation table (MOT) within the LMDU, load information associated with the load instruction;
detecting, by the LMDU, address aliasing between the load address and a store address of a previously issued store instruction, wherein the detecting is based on the MOT; and
forwarding, by the MOT, store information from the previously issued store instruction, wherein the store information satisfies one or more bytes of data required for the load instruction.

2. The method of claim 1 wherein the memory system includes a global memory disambiguation unit (GMDU), and wherein each LMDU in the plurality of LMDUs is coupled to the GMDU.

3. The method of claim 2 wherein the issuing includes sending, by the first LMDU, the load instruction to the GMDU.

4. The method of claim 3 further comprising marking, by the memory operation table, the load instruction as issued.

5. The method of claim 3 further comprising performing, by the GMDU, global alias checking against the load instruction, wherein the global alias checking includes one or more other LMDUs in the plurality of LMDUs.

6. The method of claim 5 further comprising providing, by the GMDU, the load instruction with one or more additional bytes of data required for the load instruction.

7. The method of claim 1 wherein the executing includes allocating, to the load instruction, a load token.

8. The method of claim 7 further comprising pausing, by the first compute slice, execution of additional load instructions, wherein a number of load tokens has been assigned, wherein the number of tokens is above a threshold value.

9. The method of claim 7 further comprising indicating to the first compute slice that load data associated with the load instruction is ready to be used.

10. The method of claim 9 further comprising releasing the load token.

11. The method of claim 10 further comprising reclaiming a space in the memory operation table where the load information was saved, wherein the reclaiming includes resetting a valid bit.

12. The method of claim 1 wherein the executing includes a second load instruction, wherein the second load instruction includes the load address.

13. The method of claim 12 further comprising rejecting, by the LMDU, the load instruction.

14. The method of claim 1 wherein the executing includes a second store instruction, wherein the second store instruction is associated with the load address.

15. The method of claim 14 further comprising coalescing, in the LMDU, new store information associated with the second store instruction, with the store information.

16. The method of claim 1 wherein the distributing includes allotting a second slice task to a second compute slice within the plurality of compute slices.

17. The method of claim 16 further comprising initializing pointers, wherein a head pointer points to the first compute slice, and wherein a tail pointer points to the second compute slice.

18. The method of claim 17 wherein the head pointer points to a slice task that is running non-speculatively.

19. The method of claim 1 wherein the plurality of compute slices is coupled in a ring configuration.

20. A computer program product embodied in a non-transitory computer readable medium for checking memory operations, the computer program product comprising code which causes one or more processors to generate semiconductor logic for:
accessing a processing unit comprising a plurality of compute slices, a control unit, a plurality of local memory disambiguation units (LMDUs), and a memory system, wherein each compute slice within the plurality of compute slices includes at least one execution unit, and is coupled to a successor compute slice and a predecessor compute slice, wherein each compute slice within the plurality of compute slices is coupled to an LMDU in the plurality of LMDUs;
distributing, by the control unit, a first slice task to a first compute slice within the plurality of compute slices, wherein the first compute slice is coupled to a first LMDU within the plurality of LMDUs;
executing, by the first compute slice, the first slice task, wherein the first slice task includes a load instruction, and wherein the load instruction includes a load address;
issuing, by the first compute slice, the load instruction to the first LMDU, wherein the issuing includes saving, in a memory operation table (MOT) within the LMDU, load information associated with the load instruction;
detecting, by the LMDU, address aliasing between the load address and a store address of a previously issued store instruction, wherein the detecting is based on the MOT; and
forwarding, by the MOT, store information from the previously issued store instruction, wherein the store information satisfies one or more bytes of data required for the load instruction.

21. A computer system for checking memory operations:
a memory which stores instructions;
one or more processors coupled to the memory, wherein the one or more processors, when executing the instructions which are stored, are configured to:
access a processing unit comprising a plurality of compute slices, a control unit, a plurality of local memory disambiguation units (LMDUs), and a memory system,
wherein each compute slice within the plurality of compute slices includes at least one execution unit, and is coupled to a successor compute slice and a predecessor compute slice, wherein each compute slice within the plurality of compute slices is coupled to an LMDU in the plurality of LMDUs;
distribute, by the control unit, a first slice task to a first compute slice within the plurality of compute slices, wherein the first compute slice is coupled to a first LMDU within the plurality of LMDUs;
execute, by the first compute slice, the first slice task, wherein the first slice task includes a load instruction, and wherein the load instruction includes a load address;
issue, by the first compute slice, the load instruction to the first LMDU, wherein the issuing includes saving, in a memory operation table (MOT) within the LMDU, load information associated with the load instruction;
detect, by the LMDU, address aliasing between the load address and a store address of a previously issued store instruction, wherein the detecting is based on the MOT; and
forward, by the MOT, store information from the previously issued store instruction, wherein the store information satisfies one or more bytes of data required for the load instruction.
